(19) United States
(12) Patent Application Publication
(10) Pub. No.: US 2015/0275075 A1
(43) Pub. Date: Oct. 1, 2015

(54) COLORANT COMPOSITIONS AND METHOD OF MAKING

(71) Applicant: Disney Enterprises, Inc., Burbank, CA (US)

(72) Inventor: Susan Dain, Montrose, CA (US)

(21) Appl. No.: 14/227,300

(22) Filed: Mar. 31, 2014

(51) Int. Cl. C09K 11/06

(52) U.S. Cl. CPC C09K 11/06; C09K 2211/00

(57) ABSTRACT

Colorant compositions include a transparent or translucent visible light colorant, a UV fluorescent pigment, and a UV blocking compound. Articles can be printed or coated with the colorant compositions. The colorant compositions have an appearance whereby the wavelength range of visible light viewable by the average human eye when a printed or coated article is irradiated by UV light at least partially overlaps with the wavelength range of the visible light viewable by the average human eye when the printed or coated article is irradiated by white light.

### TECHNICAL FIELD

The disclosures herein relate generally to ink and paint compositions for viewing in both visible light and UV light conditions.

### BACKGROUND

Fluorescence is the emission of light by a substance that has absorbed light or other electromagnetic radiation. Fluorescence is a form of luminescence. Fluorescence occurs due to the relaxation of excited electrons of a molecule after irradiation. After an electron absorbs a high energy photon the system is excited electronically and vibrationally. The system relaxes vibrationally, and eventually fluoresces at a longer wavelength and therefore with lower energy, than the absorbed radiation.

The most striking examples of fluorescence occur when the absorbed radiation is in the ultraviolet (UV) region of the spectrum, and thus invisible to the human eye, and the emitted light is in the visible region. Thus, light that is invisible to the human eye is converted to visible light that originates at the site of the fluorescent molecules.

The fluorescence of certain pigments when irradiated by UV-A light, also known as “black light,” has been advantageously used to form paints that are invisible or nearly invisible to the average human eye, yet glow when irradiated by UV-A lamps. However, the appearance of the UV-A pigments in white light is that the paints are either invisible, or nearly invisible, or appear as a dull “ghostlike” image.

It would be advantageous for the art and entertainment industries to provide colorant compositions, i.e. inks and paints, that effectively match the hue and value of a visible colorant, viewed under visible light, with the hue and value of the same colorant composition viewed under UV light. Due to the limited palette of UV fluorescent pigments, this has been a very difficult task in the past.

### SUMMARY

Disclosed herein is a colorant composition comprising a transparent or translucent visible light colorant, a UV fluorescent pigment, and a UV blocking compound. In some embodiments, the colorant composition further comprises one or more of a binder, a solvent, or a coalescing solvent. In some embodiments, the colorant composition is a latex paint, a lacquer, or a printing ink. In some embodiments, the UV fluorescent pigment emits visible light when irradiated with UV-A radiation. In some embodiments, the wavelength range of light emitted by the UV fluorescent pigment is selected to at least partially overlap with the wavelength range of the visible light transmitted or reflected when the visible light colorant is irradiated with white light. In some embodiments, the wavelength range of light emitted by the UV fluorescent pigment is within 1 nm to 100 nm of the wavelength range of the visible light transmitted or reflected when the visible light colorant is irradiated with white light. In some embodiments, the composition has an appearance whereby the wavelength range of visible light viewable by the average human eye when the coated substrate is irradiated by UV light at least partially overlaps with the wavelength range of the visible light viewable by the average human eye when the coated substrate is irradiated with white light. In other embodiments, the composition has an appearance whereby the wavelength range of visible light viewable by the average human eye when the coated substrate is irradiated by UV light at substantially overlaps with the wavelength range of the visible light viewable by the average human eye when the coated substrate is irradiated with white light.

Also disclosed herein is an article comprising a colorant composition disposed on at least a portion of a surface thereof, the colorant composition comprising a transparent or translucent visible light colorant, a UV fluorescent pigment, and a UV blocking compound. In some embodiments, the colorant composition further comprises a binder that is transparent or translucent to both white light and the UV light wavelengths that cause the UV fluorescent pigment to fluoresce. In some embodiments, the article is a canvas, a piece of glass, a wall, a building, a vehicle, an amusement park ride, or a sheet comprising paper, a woven or nonwoven fabric, metal, a thermoplastic polymer, or a combination of two or more thereof. In some embodiments, the portion of the article having the colorant composition disposed thereon has an appearance whereby the wavelength range of visible light viewable by the average human eye when the coated substrate is irradiated by UV light at least partially overlaps with the wavelength range of the visible light viewable by the average human eye when the coated substrate is irradiated with white light. In some embodiments, the disposing is accomplished by brushing, rolling, printing, or spray gun application including airbrushing.

Also disclosed herein is a system for formulating a colorant composition, the system comprising at least three reservoirs, wherein each of the three reservoirs is in communication with a computer that directs the system to dispense a selected amount of the contents of each reservoir in a single location, the three reservoirs individually comprising a transparent or translucent visible light colorant, a UV fluorescent pigment, and a UV blocking compound. In some embodiments, the system is a latex paint formulation system and the location is a container; wherein one or more of the reservoirs further comprises a binder and a coalescing solvent; and wherein the system further comprises a mixing mechanism to mix the dispensed contents. In some embodiments, the system is an inkjet printer, the reservoirs are inkjet cartridges, and the location of dispensing is on an article; wherein the computer directs the system to repeat the dispensing a selected number of times at a selected number of locations. In some embodiments, the system comprises at least seven reservoirs, wherein the first, second, and third reservoirs comprise three different transparent or translucent visible light colorants, the fourth, fifth, and sixth reservoirs comprise three different UV fluorescent pigment, and the seventh reservoir comprises at least a UV blocking compound. In some embodiments, the system further comprises an additional reservoir comprising carbon black.

### BRIEF DESCRIPTION OF THE DRAWINGS

FIG. 1 is a schematic representation of a system for formulating a paint colorant composition.

FIG. 2A is a schematic representation of a coating of a colorant composition of the invention.

FIG. 2B is the coating of FIG. 2A, irradiated by visible light.

FIG. 2C is the coating of FIG. 2A, irradiated by UV light.

FIG. 3A is a schematic view of the interior compartment of an amusement ride including an article printed using an ink colorant composition, illuminated by white light only.

FIG. 3B is the schematic view of FIG. 3A, illuminated by UV light only.

FIG. 4 is a schematic representation of a computer system useful in conjunction with the colorant compositions.

### DETAILED DESCRIPTION

Definitions

As used herein, “visible” means detectible by the eye of an average human. As used herein, “invisible” means not detectible by the eye of an average human, or slightly visible to the eye of an average human such that visibility is perceived as shading or a difference in surface texture.

“Visible light” is electromagnetic radiation having a wavelength or group of wavelengths within the range of wavelengths the average human eye can perceive, approximately from 390 nm to 700 nm produced by reflection, transmission, or emission.

“White light” is a combination of most or all of the wavelengths of visible light reflected, transmitted, or emitted by a source.

CIE L*a*b* (CIELAB) is a device-independent reference description of all colors visible to the human eye. The three coordinates of CIELAB represent the lightness of the color (L*=0 yields black and L*=100 indicates diffuse white), its position between red/magenta and green (a*, negative values indicate green while positive values indicate magenta) and its position between yellow and blue (b*, negative values indicate blue and positive values indicate yellow).

As used herein, “hue” or “color” means a color as perceived by the average human eye and further as referenced by wavelength range, or by two dimensions, a* and b* in the CIELAB colorspace. “Color” is a label for electromagnetic radiation having a wavelength or group of wavelengths that is a subset of the visible spectrum wherein the spectrum of light arriving at a human eye determines the color sensation in that direction. The ability of the human eye to distinguish colors is based upon the varying sensitivity of different cells in the retina to light of different wavelengths.

As used herein, “brightness” means the light-dark parameter defined as L* in the CIELAB colorspace.

As used herein, “luminosity” means the brightness of visible light emitted by a fluorescent colorant when irradiated by UV light.

As used herein, “colorant” means a dye, pigment, or combination thereof. The colorant is opaque, transparent, or translucent as indicated and in context.

As used herein, “UV radiation”, “UV light”, or “UV” means electromagnetic radiation having wavelength range between 100-400 nm UV radiation includes one or more of UV-A radiation, UV-B radiation, UV-C radiation, or an overlapping range thereof. UV-A radiation, also referred to herein as “black light”, is ultraviolet light having wavelengths of 315-400 nm UV-B radiation is ultraviolet light having wavelengths of 280-315 nm UV-C radiation is ultraviolet light having wavelengths of 100-280 nm.

As used herein, “UV fluorescent pigment” means a pigment that absorbs UV light and emits visible light.

As used herein, “UV blocking compound” is a compound or blend of compounds that blocks UV radiation by absorption or reflection/scattering. The UV radiation blocked by the UV blocking compound is determined by the compound structure and form (e.g. nanoparticulate vs. soluble molecules) and is selected by the user to block a desired range of UV wavelengths.

As used herein, the word “about” modifying, for example, the quantity of an ingredient in a composition, concentration, volume, process temperature, process time, yield, flow rate, pressure, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities.

As used herein, the word “substantially” modifying, for example, the type or quantity of an ingredient in a composition, a property thereof, a measurable quantity or property of a composition, image, or method of the invention or like values, and ranges thereof, employed in describing the embodiments of the disclosure, refers to variation in the type or amount of materials included in compositions, physical properties of the compositions, images formed using the compositions including physical properties of the images, or methods of using the compositions or images, that do not affect the overall properties thereof in a manner that negates an intended property. Intended properties include, solely by way of nonlimiting examples thereof, concentration, luminosity, fluorescence, wavelength, color, visibility, and the like. The effect on properties that are modified by “substantially” include the effects caused by any type or amount of materials in a formulation to one or more properties of a composition, a method of use, or an image, wherein the manner or degree of the effect does not negate one or more intended properties; and like proximate considerations. Where modified by the term “substantially” the claims appended hereto include equivalents to these types and amounts of materials.

Overview

Described herein is a method of color matching, a colorant composition, and articles coated or printed with the colorant composition. Using the described methods, color matching is accomplished between a color visible when a colorant composition is irradiated with white light and a color that is visible when the same colorant composition is irradiated with UV light. The colorant composition includes a colorant that transmits a color that is visible when the composition is irradiated by visible light, a pigment that emits visible light when irradiated by UV light, and a UV blocking compound. When viewed by an average human eye, the composition or an article coated with the composition has substantially the same hue and value when irradiated by white light and by UV light. The difference perceived by a viewer when viewing the composition or coated article in white light vs. UV light is that the color under UV light also has a luminosity; that is, it glows by virtue of the visible light emitted from the composition or coating itself.

The effect is achieved primarily by combining a transparent or translucent visible light colorant with a pigmented UV fluorescent colorant that fluoresces to emit light in the visible spectrum, and further by employing the UV blocking compound to limit the visible light emission by the fluorescent pigment. The hue and value of the UV fluorescent pigment when irradiated by UV light is selected to be as close as possible to the hue and value of the visible light colorant when irradiated by white light. The UV blocking compound reduces the brightness of emitted visible light by the UV fluorescent pigment without affecting the appearance of the visible light color (such as would be the case if a black pigment were employed).

When the colorant composition is irradiated by white light, the transparent or translucent visible light colorant is visible to the average human eye and appears substantially the same as the visible light colorant appears when used without the UV fluorescent pigment and the UV blocking compound.

When the colorant composition is irradiated by UV light, the visible light colorant is not visible to the average human eye as a direct result of the UV irradiation. However, the UV fluorescent pigment absorbs the UV light and itself emits visible light. The visible light must traverse the transparent or translucent visible light colorant before exiting the composition or coating thereof to reach the viewer's eye. Thus, the visible light irradiated by the UV fluorescent pigment “lights up” the visible light colorant from within the paint coating.

This effect causes the color of the colorant composition, when irradiated by UV light, to be closer to the color of the colorant composition when irradiated by white light. However, in many embodiments the luminosity of the UV fluorescent pigments is sufficient to dominate the visible color perceived by the viewer. UV fluorescent pigments are selected, in many commercial embodiments, for maximum luminosity; that is, the maximum amount of light emitted per photon of UV light absorbed. In some embodiments, the wavelength(s) of visible light emitted by the UV fluorescent pigment are of a sufficient luminosity that a viewer perceives substantially only the emitted light from the UV fluorescent pigment. In such embodiments, the UV blocking compound is usefully employed to reduce the amount of light (or intensity) emitted by the UV fluorescent pigment when irradiated by UV light. This in turn allows a balance between the visible light emitted and the color formed by the emitted visible light traversing the composition or coating thereof, such that the average human eye sees a color that appears substantially the same as the color transmitted by the visible light colorant itself when irradiated with white light.

In embodiments where a very dark color is desired, for example dark green, a minor amount of black pigment, such as carbon black, is further included in the colorant compositions. In embodiments where a very light color is desired, for example a light pink, a minor amount of a visible white pigment such as TiO₂ is further included in the colorant compositions. In embodiments where a fully saturated color requires additional colorant for purposes of color matching under UV irradiation, a transparent UV colorant is further included in the colorant compositions. In some embodiments, the colorant compositions contain both a black pigment and a UV fluorescent dye; in other embodiments the colorant compositions contain both a white pigment and a UV fluorescent dye.

Compositions

Colorant compositions are described in this section. The colorant composition includes a colorant that transmits or reflects a color that is visible when the composition is irradiated by visible light, a pigment that emits visible light when irradiated by UV light, and a UV blocking compound. In some embodiments, these three components are collectively referred to herein as “coloring components”. In some embodiments, the colorant composition includes coloring components and a vehicle for delivering the composition to a substrate. The vehicles are transparent or translucent to both visible and UV light. In some embodiments, the colorant components further include a visible black pigment, a visible white pigment, a UV fluorescent dye, or a combination of two or more of these.

The visible light colorant is transparent or translucent when viewed as coated on a substrate that reflects or transmits visible light. Transparent or translucent paints are used, for example, in the automobile paint industry or for tinting, or for painting or glazing glass, or other scenic effects. By transparent or translucent, it is meant that a coating of 1 mm thickness or less on a sheet of glass allows visible light to be transmitted through the coating and the glass. In some embodiments, the visible light colorant is agglomerated into a pigment-like form but on a size scale that imparts transparency or translucency to the coatings thereof. For example, agglomerated dye molecules wherein the particle size of the agglomerate is less than about 25 nm, for example about 1 nm to 22 nm, or 3 nm to 15 nm, or 5 nm to 10 nm is translucent or even transparent in some embodiments. In some embodiments, the visible light colorant is a dye-based colorant. Any of the standard dyes employed in the ink and paint industry for making transparent coatings or for printing are usefully employed in embodiments as the transparent or translucent colorant in the colorant compositions.

In some embodiments, a commercially available visible light colorant, or a formulated paint or ink containing a visible light colorant is employed as a component in the colorant compositions. Examples of suitable commercially available visible light colorant components include NOVACOLOR® acrylic paints sold by Artex Ltd. of Ruddington, Nottinghamshire, UK; AUTOAIR COLORS® sold by Createx Distribution, LLC of East Granby, Conn.; Golden Fluid Acrylic paints sold by Golden Artist Colors, Inc. of New Berlin, N.Y.; acrylic paints sold by LIQUITEX® of Piscataway, N.J.; or any other commercially available source of waterbased paint, pigment, or dye.

UV fluorescent pigments include particulates that fluoresce when irradiated by UV-A, UV-B, or UV-C radiation, or overlapping ranges thereof, to emit visible light. Pigments are particles of agglomerated colorant molecules, in some embodiments with additional non-colorant components such as surfactants, stabilizers, and the like. In some embodiments, the pigments are in the micron-scale size regime. In other embodiments, the pigments are nanoscale. Pigment particles range in size from about 50 nm to about 50 μm, often about 50 nm to 10 μm. In some embodiments, the size of the particulate is determined by the ability of the particulate to form a stable dispersion in a liquid carrier used for delivery of the paint or ink.

In some embodiments, the pigments reflect as white, light gray, light green, off-white, or another color when irradiated by visible light, but emit an intense (bright) visible color such as magenta, green, orange, or white when irradiated by UV light of a wavelength that excites the fluorescing compound present in the pigment. In some embodiments, the pigments are invisible to the average human eye when irradiated by visible light; this is particularly true where the pigment actually reflects white when irradiated by white light, but is applied as a coating to a background that also reflects white.

The hue and value of the UV fluorescent pigment when irradiated by UV light is selected to be in the same range as the hue and value of the visible light colorant when irradiated by white light. For example, spectral violet light has a wavelength range of about 380 nm to 450 nm; a visible light colorant that appears “violet” may include wavelengths that are in only a part of that range, or include some wavelengths in a nearby range (blue) such as 400 nm to 480 nm or the like. In some embodiments, the wavelength range of light emitted by the UV fluorescent pigment is selected to at least partially overlap with the wavelength range of the visible light colorant when the visible light colorant is irradiated with white light. In other embodiments, the wavelength range of light emitted by the UV fluorescent pigment does not overlap with that of the visible light colorant but has a range that extends to within 1 nm to 100 nm of the range of the visible light colorant, or about 5 nm to 80 nm, or about 10 nm to 50 nm, or about 1 nm to 5 nm, or about 1 nm to 50 nm, or about 10 nm to 100 nm, or about 10 nm to 80 nm, of the range of the visible light colorant.

In some embodiments, a commercially available UV fluorescent pigment, or a formulated paint or ink containing a UV fluorescent pigment is employed as a component in the colorant compositions. Examples of suitable commercially available UV fluorescent pigmented components include those sold by WildFire Inc. of Torrance, Calif., DayGlo Color Corp. of Cleveland, Ohio, or Risk Reactor Inc. of Santa Ana, Calif.

The ratio of visible light colorant to UV fluorescent pigment in the colorant compositions is determined by the user and is not particularly limited. A magenta colorant composition, for example, may require a different ratio of visible light colorant to UV fluorescing colorant than a blue colorant composition to achieve the proper balance of magenta color in both white light and UV light. Thus, ratio of visible light colorant to UV fluorescent pigment suitably ranges from 1.00:99.00 to 99.00:1.00 by weight. Further, the ratio is suitably varied between 1.00:99.00 and 99.00:1.00 in increments of 0.01, for example 23.06:76.94, 90.00:10.00, 50.01:49.99, and the like. Such variability is necessary to arrive at a desired balance of color and brightness in white light conditions along with a balance of luminosity, color, and brightness in UV light conditions.

UV blocking compounds useful in the colorant compositions include UV-A blocking compounds, UV-B blocking compounds, UV-C blocking compounds, blends thereof, and compounds and blends thereof that block various ranges of UV radiation wavelengths. Generally, the UV blocking compounds are selected to block the UV wavelengths that excite the selected UV fluorescent pigment and cause it to emit visible light. UV blocking compounds usefully employed in one or more colorant compositions include various derivatives of hydroxyphenylbenzotriazole, hydroxybenzophenone, cinnamic acid, salicyclic acid, hydroxyphenyl-s-triazine, and axalanilides; avobenzone, bis-ethylhexyloxyphenol methoxyphenyl triazine (sold under the trade name TINOSORB® S by the BASF Corporation of Florham Park, N.J.), methylene bis-benzotriazolyl tetramethylbutylphenol (sold under the trade name TINOSORB® M by the BASF Corporation), terephthalylidene dicamphor sulfonic acid (sold under the trade name MEXORYL® SX by the L'Oreal Group of Clichy, Hauts-de-Seine, France), drometrizole trisiloxane (sold under the trade name MEXORYL® XL by the L'Oreal Group), hexyl 2-[4-(diethylamino)-2-hydroxybenzoyl]benzoate (sold under the trade name UVINUL® A PLUS by the BASF Corporation), ethylhexyl methoxycinnamate, p-aminobenzoic acid (PABA), 2-ethylhexyl 4-(dimethylamino)benzoate (padimate O), phenylbenzimidazole sulfonic acid, and microparticles and/or nanoparticles including titanium dioxide, silicon dioxide, or zinc oxide, and the like.

The amount of UV blocking compound included in the colorant compositions is not particularly limited. The amount of UV blocking compound is selected by the user to provide sufficiently attenuated luminosity to allow color matching with the visible light colorant. More UV blocking compound is included in colorant compositions to provide a lower L* value in the visible light emitted when the composition is irradiated by UV light, whereas higher L* values are included in colorant compositions where a higher L* value is desired in the visible light emitted when the composition is irradiated by UV light. Less emitted fluorescence by the UV fluorescent pigment results in a lower L* value of the visible light colorant when viewed under UV irradiation. Thus, the amount of UV blocking compound depends on the efficacy of the UV blocking compound (photons blocked per molecule of the blocker), the relative amounts of visible light colorant and UV fluorescent pigment, the inherent luminosity of the UV fluorescent pigment when irradiated by UV light, and the desired L* value when the emitted light of the UV fluorescent pigments is the visible light source illuminating the visible light colorant.

In general, the amount of UV blocking compound is selected to provide sufficient attenuation of the emitted light from the UV fluorescence that the viewer is able to view the color of the visible light pigment as illuminated by the emitted light and not primarily the light emitted from the UV fluorescent pigment itself. In various embodiments, the amount of UV blocking compound in the colorant compositions is 1.00 wt % to 90.00 wt % of a UV blocking compound (neat) or a composition containing a UV blocking compound based on the weight of the composition. Further, the amount is suitably varied between 1.00 wt % and 90.00 wt % in increments of 0.01 wt %, for example 23.06 wt % to 76.94 wt %, 90.00 wt % to 10.00 wt %, 50.01 wt % to 49.99 wt %, and the like. Such variability is necessary to realize a balance of color hue, color, brightness, and luminosity in white light and UV light conditions.

In embodiments where a very dark color is desired, for example dark green or brown, a minor amount of black pigment, such as carbon black, is further included in the colorant compositions. The visual effect of carbon black on the colorant composition is to lower the L* value of both the visible light colorant and the visible light emitted by the UV colorant. This dual effect is the result of attenuating the luminosity of the UV light, while providing substantially no reflectance of white light generated by the UV fluorescent pigments under UV irradiation. While not particularly limited as to particle size, carbon black particulates employed as pigments in inks and paints are typically about 10 nm to 5 μm, in embodiments about 25 nm to 1 μm, or about 35 nm to 500 nm, to provide good opacity while providing a stable dispersion of the particulates in the liquid delivery vehicle employed for the paint or ink. The amount of carbon black required in such embodiments is between about 0.010 g/l of a liquid colorant composition to 0.500 g/l of the composition, or about 0.015 g/l to 0.400 g/l, or about 0.020 g/l to 0.350 g/l, or about 0.25 g/l to 0.300 g/l of the liquid colorant composition.

In embodiments where a very light color is desired, for example a light pink, a minor amount of a visible white pigment such as TiO₂ is further included in the colorant compositions. The visual effect of white pigment on the colorant composition is to raise the L* value of both the visible light colorant and the visible light issued by the UV fluorescent pigment, while decreasing luminosity of the UV colorant itself. This dual effect is the result of the ability of pigments in general to attenuate the amount of UV light reaching the UV fluorescent pigments, thereby decreasing their luminosity, while still reflecting visible light, whether the visible light is the light used to irradiate the colorant composition or is the light generated by the UV fluorescent pigments when irradiated by UV light. While not particularly limited as to particle size, white pigment particulates employed in inks and paints are typically about 10 nm to 5 μm, in embodiments about 25 nm to 1 μm, or about 35 nm to 500 nm, to provide good opacity while providing a stable dispersion of the particulates in the liquid delivery vehicle employed for the paint or ink. The amount of white pigment required in such embodiments is between about 0.01 g/l of a liquid colorant composition to 5.00 g/l of the composition, or about 0.10 g/l to 2.00 g/l, or about 0.25 g/l to 1.00 g/l of the liquid colorant composition.

In embodiments where a fully saturated color requires additional colorant for purposes of color matching under UV irradiation, a transparent UV colorant is further included in the colorant compositions. The saturation (chroma) of a color is determined by a combination of light intensity and how of the light is distributed across the spectrum of different wavelengths. The most saturated color is achieved by using just one wavelength at a high intensity. Transparent UV fluorescent colorants, which are UV fluorescent dyes, provide an additional source of visible light color by fluorescing when irradiated by UV light, but also allow for transmission of the color generated by the combination of UV fluorescent pigments and visible light colorants under UV irradiation conditions. Further, UV fluorescent dyes do not interfere with visible color, for example by blocking reflection of visible light as pigments do when a large amount is used in a colorant composition.

In some embodiments, the colorant compositions contain, in addition to visible light colorant, UV fluorescent pigment, and UV blocking compound, both a black pigment and a UV fluorescent dye; in other embodiments the colorant compositions contain, in addition to visible light colorant, UV fluorescent pigment, and UV blocking compound, both a white pigment and a UV fluorescent dye.

In embodiments, the colorant compositions include a vehicle for delivering the coloring components to an article to form a coated article. In some such embodiments, the vehicle includes a binder, a solvent, a coalescing solvent, or a combination of two or more thereof. Components of the vehicle are selected for transparency or translucency with respect to both visible light and UV light of the selected range, that is, the range of UV light that excites the selected UV fluorescent pigment. Thus, components such as binders that reside in the coated colorant compositions after drying or curing are required to be transparent to both visible and UV light of the selected range. Solvents that evaporate upon application of the composition to an article are not required to be transparent or translucent. Vehicle components that cure are required to be transparent or translucent to both visible and UV light of the selected range after cure.

A binder is required for delivery of the coloring components in coated form, such as in a paint or in a printing ink, wherein the binder is a film-forming component. The binder imparts adhesion and strongly affects properties such as gloss, durability, flexibility, and toughness. Suitable binders include synthetic or natural resins such as alkyds, acrylics, vinyl-acrylics, ethylene-vinyl acetate copolymers, polyurethanes, polyesters, melamine resins, epoxies, or oils. Binders are categorized herein according to the mechanisms for drying or curing. “Drying” refers to evaporation of a solvent. “Curing” refers to cross-linking of the binders.

Colorant compositions that dry by solvent evaporation wherein the coloring components and a solid binder are dissolved in a solvent are lacquer colorant compositions. A solid film forms from the lacquer when the solvent evaporates. Suitable solvents for lacquer colorant compositions include water, C1-C6 alcohols, C3-C6 ketones, C2-C6 aldehydes, C1-C8 hydrocarbyl compounds (alkanes, alkenes, alkynes, cyclic, aromatic), C4-C6 ethers included cyclic ethers, blends of two or more such compounds, and the like.

In some embodiments, a lacquer colorant composition is an inkjet ink or a flexographic ink and the colorant composition is printed using inkjet or flexographic printing methodology. In a related embodiment, the solvent employed in the inkjet or flexographic ink also becomes a binder via UV curing after printing, wherein a photoinitiator is further included. In such embodiments, the UV wavelength employed to cure the colorant composition is different from the UV wavelength blocked by the UV blocking compound.

Powder coated colorant compositions are those that include little or no solvent, wherein flow and cure of the colorant composition is produced by electrostatic application of a dry powder containing the coloring components and a binder followed by heating to coalesce the binder. Electrostatic printing and electrostatic painting methods are both suitably employed using the powder coating colorant compositions; electrostatic printing is suitably employed in e.g. laser printing.

Latex colorant compositions (paints) are water-borne dispersions that include at least the coloring components, a binder, and one or more coalescing solvents. Polymeric binders commonly employed in latex paints are acrylics, vinyl alcohol and vinyl acetate copolymers, styrene acrylic copolymers, and the like. Coalescing solvents are those that evaporate more slowly than water at typical ambient indoor temperatures (17° C. to 23° C.) and provide for coalescence of the binders during the drying of the paint to form a substantially continuous coating. Coalescence occurs after initial evaporation of water, when the binder particles are softened, then fused together by the residual coalescing solvent, resulting in film formation and a network structure that does not redissolve in the original solvents. In some embodiments, latex colorant compositions further include one or more surfactants and/or rheology modifiers for latex stabilization, to facilitate smooth, continuous coatings, to affect surface glossiness, or some combination of these.

Latex colorant compositions that cure by oxidative crosslinking are generally single package coatings. When applied, the exposure to oxygen in the air starts a process that crosslinks and polymerizes the binder component. Alkyd enamels are usefully employed in the colorant compositions as binder resins that cure by an oxidative reaction. Epoxies and polyurethanes are examples of two-package binder materials that cure by polymerization, wherein the coloring components are included in one package or are divided between two packages, depending on compatibility.

In some embodiments, the colorant compositions include one or more additives to modify surface tension, improve flow properties, improve the finished appearance of a coating, increase wet edge of a coating, improve pigment dispersion stability, impart antifreeze properties, control foaming, control skinning after application, and the like. Suitable types of additives include cure catalysts, rheology modifiers, thermal stabilizers, emulsifiers, texturizers, adhesion promoters, stabilizers, flatteners (de-glossing agents), biocides, and the like. In some embodiments, the additives are present in the colorant compositions in an amount of about 0.0001 wt % to 3 wt % based on the weight of the composition.

It is an advantage that the colorant compositions are formed using standard methodology that is well established in the art. Lacquer colorant compositions, powder coated colorant compositions, and latex colorant compositions are all made using methodology familiar to one of skill in making paints or printing inks. In some embodiments, components are simply admixed at the desired ratio. In some such embodiments, a commercially formulated transparent visible light paint or ink is admixed with a commercially formulated UV fluorescent pigment paint or ink, further with at least a UV blocking compound, to form a colorant composition. In some embodiments, a commercially formulated transparent visible light paint or ink is admixed with a UV fluorescent pigment, further with at least a UV blocking compound, to form a colorant composition. In other embodiments, a transparent visible light colorant is admixed with a commercially formulated UV fluorescent pigment paint or ink, further with at least a UV blocking compound, to form a colorant composition.

Methods

Method of color matching using components of the colorant compositions are described in this section.

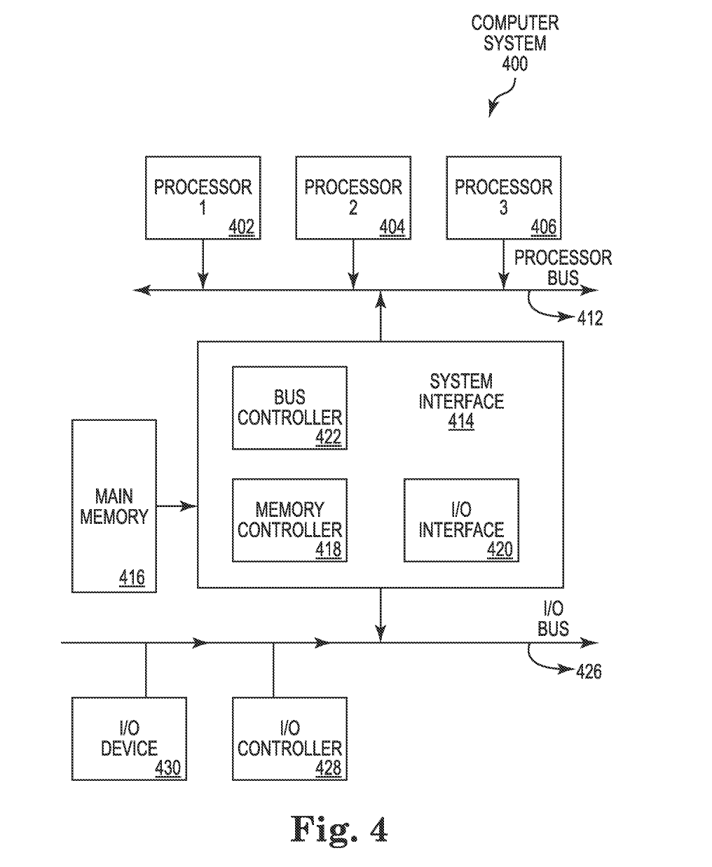

In some embodiments, a computer system is employed to determine a color matching combination of the colorant composition components, and/or direct one or more automated systems to produce the colorant compositions. One such computer system is shown in FIG. 4. The computer system (system) includes one or more processors 402-406 that may include one or more internal levels of cache (not shown) and a bus controller or bus interface unit to direct interaction with the processor bus 412. Processor bus 412 may be used to couple the processors 402-406 with the system interface 414. System interface 414 may be connected to the processor bus 412 to interface other components of the system 400 with the processor bus 412, such as a main memory 416. System interface 414 may also include an input/output (I/O) interface 420 to interface one or more I/O devices with the processor bus 412. One or more I/O controllers and/or I/O devices may be connected with the I/O bus 426, such as I/O controller 428 and I/O device 430, as illustrated.

System 400 may include a dynamic storage device, referred to as main memory 416, or a random access memory (RAM) or other devices coupled to the processor bus 412 for storing information and instructions to be executed by the processors 402-406. System 400 may include a read only memory (ROM) and/or other static storage device coupled to the processor bus 412 for storing static information and instructions for the processors 402-406. According to one embodiment, the above techniques may be performed by computer system 400 in response to processor 404 executing one or more sequences of one or more instructions contained in main memory 416. These instructions may be read into main memory 416 from another machine-readable medium, such as a storage device. Execution of the sequences of instructions contained in main memory 416 may cause processors 402-406 to perform the process steps described herein. The system set forth in FIG. 4 is but one possible example of a computer system that may employ or be configured in accordance with aspects of the present disclosure.

While use of a computer system is efficient for producing large amounts of colorant compositions e.g. for commercial sale, it is an advantage of the colorant compositions that a computer matching system is not necessary. In embodiments, an individual artist mixes materials to achieve the desired visual effect by combining a UV fluorescent pigment that emits light in a wavelength range that approximates the color of the visible light colorant, and by checking illumination with a UV lamp, add the desired amount of UV blocking compound to the mixture of colorants to achieve a color matched composition wherein the hue and value of the color viewed when irradiated by white light is very close or the same as the color viewed when irradiated with UV light. Because the color of emitted light from the UV fluorescent pigment does not have to closely match the color of the visible light colorant, a computer matching system is not required.

When coated or printed on a substrate and dried and/or cured, the colorant composition has an appearance whereby the wavelength range of visible light viewable by the average human eye when the coated substrate is irradiated by UV light at least partially overlaps with the wavelength range of the visible light viewable by the average human eye when the coated substrate is irradiated with white light. The appearance difference perceived by a viewer viewing under white light vs. under UV light is primarily that the composition under UV light appears to glow. This difference stems from the fact that the visible light source under UV light resides within the composition itself.

In an exemplary embodiment, these color matching methods are coupled to a latex paint mixing apparatus that receives the computer direction for amounts of components and directs at least three reservoirs to add previously determined amounts of components to a container in order to form a latex colorant composition. In such embodiments, one reservoir contains at least a UV fluorescent pigment, one reservoir contains at least a visible light colorant, and one reservoir contains at least a UV blocking compound. Solvents, binders, and the like are suitably included along with one or all of the reservoir components. The three components are added in the selected ratio to a single container and are mixed to form a latex colorant composition. In some embodiments, carbon black is included in a fourth reservoir for addition where very dark (low L*) colors are desired.

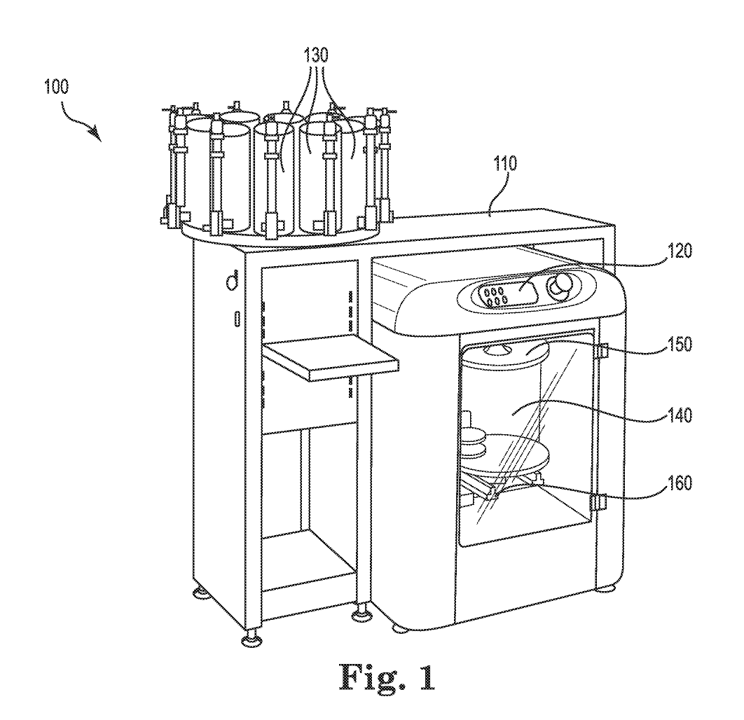

FIG. 1 is a schematic representation of a latex paint mixing apparatus that is useful to mix a latex paint colorant composition. Apparatus 100 includes frame 110, computer controlled module 120, and reservoirs 130 that hold components of the latex paint colorant compositions. Computer controlled module 120 directs the release of specified amounts of the components from reservoirs 130 through a system of tubes and valves (not shown) to container 140. Container 140 has lid 150 which secures the added components therein during mixing. After addition of the components to the container 140, the container 140 is shaken by rapid motion of arm mount 160 that also secures container 140 and lid 150 during the shaking. A user is then able to remove container 140 from the apparatus 100, wherein the container 140 contains a finished latex paint colorant composition.

In some embodiments of the latex paint mixing apparatus, three UV fluorescent pigment colorants are employed in three separate reservoirs, and three visible light colorants are employed in three separate reservoirs; in such a system, at least seven separate reservoirs are included as part of the latex paint mixing apparatus. The three UV fluorescent pigment colorants are selected for those that emit red, green, and blue light when irradiated; or those that emit cyan, yellow, and magenta light when irradiated. The three visible light colorants are red, green, and blue or cyan, magenta, and yellow when irradiated by visible light. The computer direction to the latex paint mixing apparatus further includes directions for mixing each of the sets of three colorants to achieve the same target visible light color (emitted or reflected/transmitted), and the UV blocking compound is added to achieve the selected luminosity of the UV fluorescent pigment when irradiated by UV light. In some embodiments, carbon black is included in an eighth reservoir for addition where very dark (low L*) colors are desired.

Application of the colorant compositions to a substrate is accomplished by direct application or by printing. Direct application includes application using a brush, roller, blade, spray gun, or fingers/hands. Printing includes screen printing, flexography, inkjet printing, laser printing, gravure printing, and the like.

In another exemplary embodiment, the colorant composition is formed upon printing the components separately onto a substrate. Inkjet printing of UV fluorescent pigments, visible light colorants, and the UV blocking compound are suitably carried out separately, wherein three UV fluorescent pigment colorants are provided as inkjet inks in three separate inkjet cartridges, and three visible light colorants are provided as inkjet inks in three inkjet cartridges, and the UV blocking compound is provided yet another inkjet ink cartridge; in such a system, at least seven inkjet cartridges are included as part of the inkjet printing apparatus. The three UV fluorescent pigment colorants are selected for those that emit red, green, and blue light when irradiated; or those that emit cyan, yellow, and magenta light when irradiated. The three visible light colorants are red, green, and blue or cyan, magenta, and yellow when irradiated by visible light. The computer direction to the inkjet printer further includes directions for jetting droplets onto a substrate to achieve a target visible light color (emitted or reflected/transmitted), and the UV blocking compound is printed over the UV fluorescent pigments in an amount suitable to modify the luminosity thereof. In some embodiments, carbon black is included in an eighth reservoir for addition where very dark (low L*) colors are desired.

Coated Articles

Articles coated with the colorant composition and methods of making the coated articles are described in this section.

In some embodiments, the colorant compositions are painted onto an object, such as a wall, a figure, an architectural element or a portion thereof, a sheet, a film, and the like. In other embodiments, the colorant compositions are printed onto an object to form a poster, mural, drawing, diagram and so on. In one exemplary embodiment, a latex colorant composition is painted onto a wall. In another exemplary embodiment, the colorant composition is printed onto a sheet and the sheet is adhered to a wall. In general, the colorant compositions are applied to any object in any manner as currently known or hereafter developed to apply a color to a two- dimensional or three-dimensional object.

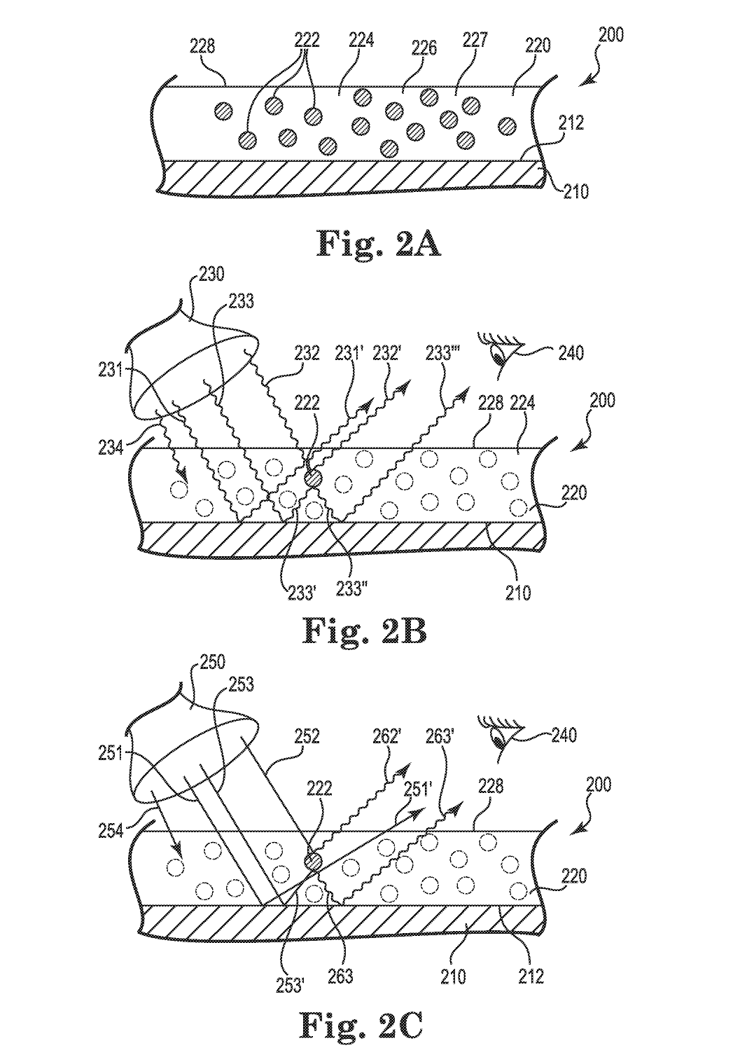

After application of a colorant composition to a surface and drying, curing, or coalescing the composition, a coated surface 200 as shown in FIG. 2A is formed. Coated surface 200 includes article 210 having surface 212 with a dried and/or cured latex coating 220 disposed thereon. Coating 220 includes UV-A fluorescent pigment particles 222 dispersed within a continuous coating matrix 224. Continuous matrix 224 includes visible light colorants 226 and UV absorbing agent 227 dispersed homogeneously in matrix 224. Coating 220 extends from article surface 212 to coating surface 228, defining a coating thickness, wherein thickness 228,212 defines a direction generally from coating surface 228 toward article surface 212 and thickness 212, 228 defines a direction generally from article surface 212 toward coating surface 228. Continuous matrix 224 is transparent or translucent to a range of wavelengths corresponding to a color determined by the composition of visible light colorants 226. Article surface 212 reflects all visible light and thus, without any coating thereon, appears white under white light.

FIG. 2B shows coated surface 200 wherein white light source 230 is directed towards coated surface 200; only one pigment particle 222 is shown for clarity and because the dispersion of particles 222 throughout coating 220 is three dimensional, such that photons emitted from light source 230 may encounter only a single surface or pigment particle. Photons of white light 231, 232, 233 travel from source 230 to surface 228 of coating 220 and into continuous matrix 224. Photon 231 traverses coating thickness 228, 212 and reflects off article surface 212. Reflected photon 231′ traverses coating thickness 212, 228 and towards the eye of a viewer 240. Photon 232 traverses a portion of the coating thickness 228, 212 and encounters a pigment particle 222. Pigment particle 222 does not absorb photon 232 and instead reflects it. Reflected photon 232′ traverses a portion of thickness 212, 228 and is projected towards the eye of a viewer 240. Photon 233 traverses coating thickness 228, 212 and reflects off article surface 212. Reflected photon 233′ traverses a portion of thickness 212, 228 and encounters pigment particle 222. Pigment particle 222 does not absorb reflected photon 233′ and instead reflects it. Photon 233″ traverses a portion of coating thickness 228, 212 and is reflected off article surface 212. Finally, photon 233′″ traverses coating thickness 212, 228 and is projected towards the eye of a viewer 240. Photons 231′, 232′, and 233′″ that exit coating 220 are those of a visible light wavelength corresponding to the selected color of when viewed by the eye of a viewer 240, having been transmitted by visible light colorants 226. Photon 234 has a wavelength that differs from the wavelengths transmitted by visible light colorants 226 and thus traverses coating surface 228 and is absorbed between coating surface 228 and article surface 212.

FIG. 2C shows coated surface 200 wherein UV-A light source 250 directed towards coated surface 200; only one pigment particle 222 is shown for clarity and because the dispersion of particles 222 throughout coating 220 is three dimensional, such that photons emitted from light source 250 may encounter only a single surface or pigment particle. Photons of UV-A light 251, 252, 253 travel from source 250 toward surface 228 of coating 220 and into continuous matrix 224. Continuous matrix 224 is transparent or translucent to UV-A light except for the pigment particles 222 and the UV blocking compound 227. Thus, photon 251 traverses coating thickness 228, 212 and reflects off article surface 212. Reflected photon 251′ traverses coating thickness 212, 228 and towards the eye of a viewer 240; viewer 240 cannot perceive photon 251′. Photon 252 traverses a portion of the coating thickness 228, 212 and encounters a pigment particle 222. Pigment particle 222 absorbs photon 252 and emits a photon of visible light 262. Emitted photon 262 traverses a portion of thickness 212, 228 and is projected towards the eye of a viewer 240, having been transmitted by visible light colorants 226. Photon 253 traverses coating thickness 228, 212 and reflects off article surface 212. Reflected photon 253′ traverses a portion of thickness 212, 228 and encounters pigment particle 222. Pigment particle 222 absorbs photon 233′ and emits a photon of visible light 263. Photon 263 traverses a portion of coating thickness 228, 212 and is reflected off article surface 212. Finally, photon 263′ traverses coating thickness 212, 228 and is projected towards the eye of a viewer 240. Photons 262, 263′ that exit coating 220 are those of a visible light wavelength corresponding to a color when viewed by the eye of a viewer 240. Other photons that are emitted from pigment particle 222 that are not of the wavelength transmitted by visible light colorants 226 are instead absorbed by coating 220. Photon 254 traverses a portion of coating thickness 212, 228 and is absorbed by UV blocking compound 227 before reaching a pigment particle.

A wide range of articles are conveniently and easily coated with the colorant compositions. In some embodiments, the article is a film or sheet material that is directly coated with the colorant compositions or printed using a print method of applying the colorant compositions, for example using inkjet printing as disclosed above. Examples of film or sheet materials usefully coated or printed include coated and uncoated papers, paperboard, and corrugated board, foils and metallized films or papers, and a wide range of thermoplastic films and sheets formed, in some embodiments, from polyethylene, polypropylene, polyester, polyvinyl chloride, polyvinylidene chloride, nylon, and the like including blends thereof and multilayer films using two or more thereof. In some embodiments, the substrates are coated with a specialized coating adapted to receive a particular type of ink or other liquid coating; for example, thermoplastic sheets often have a water-absorptive coating thereon for use with waterbased inkjet inks. Small format printing, such as for letter size paper or labels, as well as large format printing is usefully carried out using known print technologies in conjunction with the ink colorant compositions as described.

Large format printing or coating includes printing or coating of the colorant compositions on films and sheets, in some embodiments with an adhesive backing, for use as murals, posters, amusement park ride parts, including covers of compartments or displays on the inside thereof, advertisement or decorative adhesive “wraps” for vehicles such as cars, vans, buses, ride compartments, and the like. In some embodiments where the substrate is intended to cover a window, windshield, or other transparent area, a portion or the entirety of the substrate area for covering the transparent area is perforated. In some such embodiments, the back side surface of the substrate includes a black or gray pigment so that a viewer on the image side of the covered transparent area sees the printed image, while a viewer on the other side of the covered transparent area is able to see through the transparent area. In some embodiments, large format sheets are formed from polyvinylchloride or a woven or nonwoven fabric. In some embodiments, large format sheets are 1 meter wide and up to about 10 meters wide, though the width is limited only by the ability of the printer to accommodate the width format. The length of large format sheets are not particularly limited; often such sheets are available in roll format and thus length is selected by sizing the image and cutting the length to match the image size.

In some embodiments, articles usefully printed using the colorant compositions described herein are intended to transfer a printed image from the article onto a second article; examples of such substrates are iron-on printable sheets for making images on fabric or another article that is not conveniently printed using a traditionally configured printer, and “temporary tattoos” or other transfer substrates for transferring an image onto human skin, or onto walls or other articles. Nonwoven webs and woven or felted fabrics formed from natural or synthetic fibers can also be printed or painted using the colorant compositions described herein.

In some embodiments, where large areas are covered with a single colorant composition, the colorant composition is supplied as a latex colorant composition and the latex is spread onto the article using a brush, roller, or spray gun. In other embodiments, a series of lacquer colorant compositions or latex colorant compositions are formulated as an artist's paint set. In such embodiments, jars, cans, or tubes of lacquer or latex are provided for individual use and are useful to form images on articles including canvas, windows, walls (murals), and the like using paintbrushes, blades, and the like and further can be mixed by the artist to create customized colors.

One advantage of applying the colorant compositions on one or more objects is realized in a location where both white light and UV light sources are used. One exemplary such location is an amusement park, where a ride travels through or is exposed to both white light and black light (UV-A) conditions for the enjoyment of the ride patrons. As the irradiation wavelengths shift, the color compositions coated on the interior, exterior, or both appear to have the same hue and value, but under black light the color glows as a result of the visible light source being the emission from the UV fluorescent pigments present in the colorant. Thus, for example, bringing a volcano “to life” by causing it to glow; forming a glowing area on a surface by focusing a black light beam on one area; moving such a focused beam around the area to appear to form a glowing area that moves; and the like are advantageously used to create special effects in one or more amusement park features.

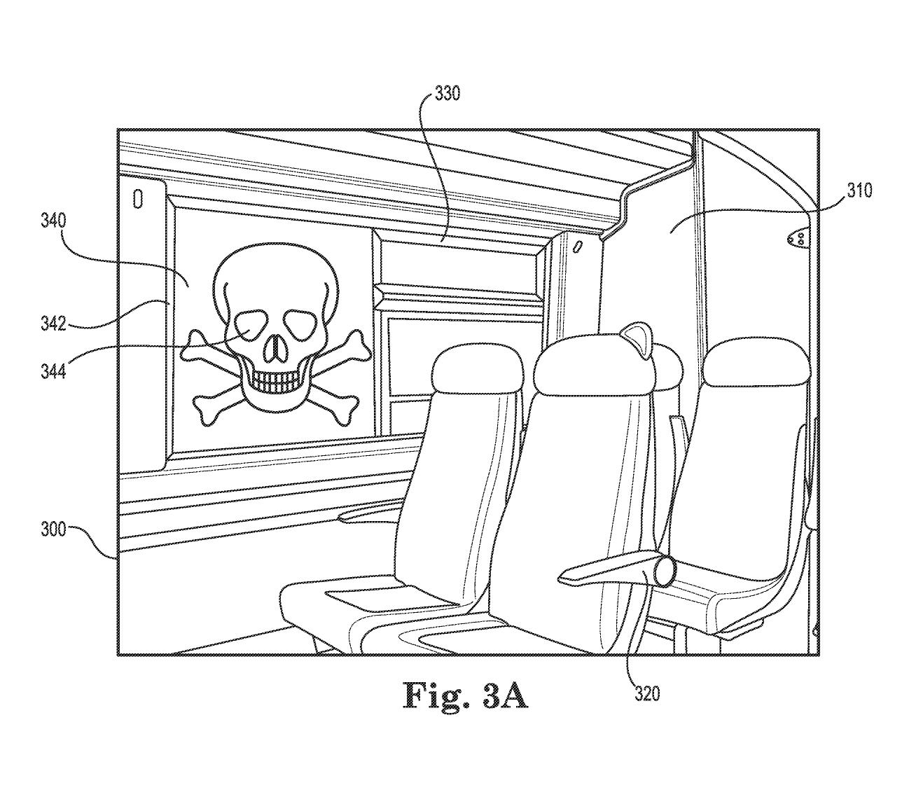

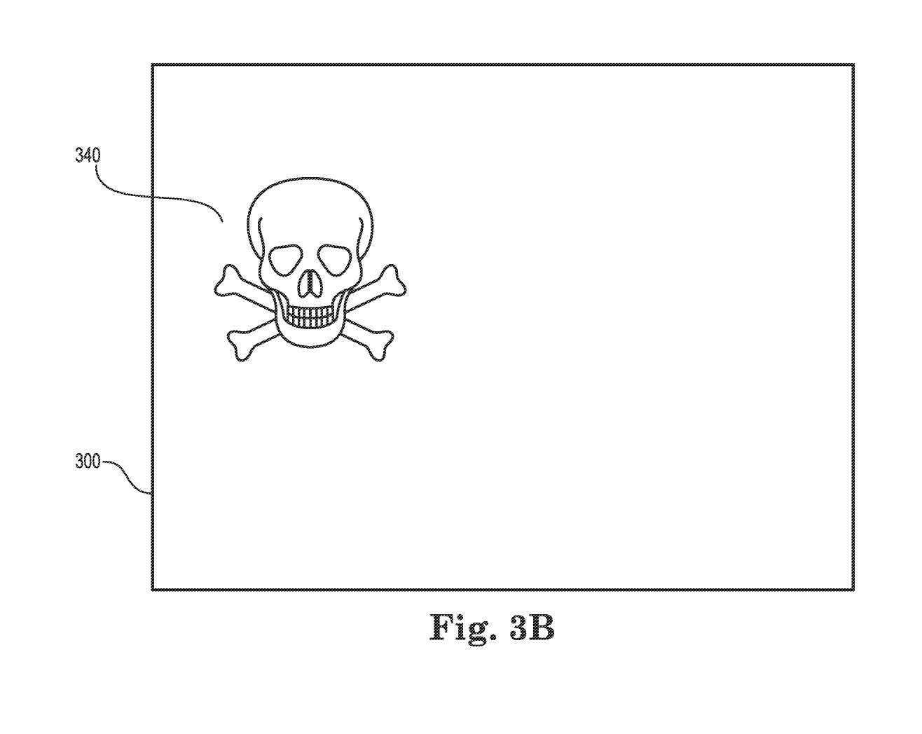

FIGS. 3A and 3B show an exemplary use of a painted image employing a colorant composition. FIG. 3A shows the interior module of an amusement park ride 300. Interior module 300 is illuminated by an external white light source (not shown) in FIG. 3A. Interior module 300 includes viewing area 310 and seating 320 for patrons. Viewing area 310 includes an image 340 painted thereon using standard black paint and a color composition. Image 340 includes a black portion 342 and a colored portion 344 painted on a portion of viewing area 310. Colored portion 344 is painted using a colorant composition of the invention, wherein the UV fluorescent pigment fluoresces when irradiated by UV-A light. Colored portion 344 is visible in the white light illuminating interior module 300.

FIG. 3B shows the same interior module 300 when illuminated by a UV-A light source and further in the substantial absence of external visible light sources. Only colored portion 344 is visible in the absence of an external visible light source.

Although the present disclosure provides references to preferred embodiments, persons skilled in the art will recognize that changes may be made in form and detail without departing from the spirit and scope of the invention.

1. A colorant composition comprising a transparent or translucent visible light colorant, a UV fluorescent pigment, and a UV blocking compound.

2. The colorant composition of claim 1 further comprising one or more of a binder, a solvent, or a coalescing solvent.

3. The colorant composition of claim 1 wherein the composition is a latex paint, an acrylic based paint, a lacquer, or a printing ink.

4. The colorant composition of claim 1 wherein the UV fluorescent pigment emits visible light when irradiated with UV-A radiation.

5. The colorant composition of claim 1 further comprising a black pigment, a white pigment, a UV fluorescent dye, or a combination of black pigment and UV fluorescent dye, or a combination of white pigment and UV fluorescent dye.

6. The colorant composition of claim 1 wherein the wavelength range of light emitted by the UV fluorescent pigment is selected to at least partially overlap with the wavelength range of the visible light transmitted or reflected when the visible light colorant is irradiated with white light.

7. The colorant composition of claim 1 wherein the wavelength range of light emitted by the UV fluorescent pigment is within 1 nm to 100 nm of the wavelength range of the visible light transmitted or reflected when the visible light colorant is irradiated with white light.

8. The colorant composition of claim 1 wherein the UV blocking compound comprises avobenzone, bis-ethylhexyloxyphenol methoxyphenyl triazine, methylene bis-benzotriazolyl tetramethylbutylphenol, terephthalylidene dicamphor sulfonic acid, drometrizole trisiloxane, hexyl 2-[4-(diethylamino)-2-hydroxybenzoyl]benzoate, ethylhexyl methoxycinnamate, p-aminobenzoic acid, 2-ethylhexyl 4-(dimethylamino)benzoate, phenylbenzimidazole sulfonic acid, a derivative of hydroxyphenylbenzotriazole, hydroxybenzophenone, cinnamic acid, salicyclic acid, hydroxyphenyl-s-triazine, or axalanilide; a microparticle or nanoparticle comprising titanium dioxide, silicon dioxide, or zinc oxide, or a blend of two or more thereof.

9. The colorant composition of claim 1 wherein the wavelength range of visible light viewable by the average human eye when the composition is irradiated by UV light at least partially overlaps with the wavelength range of the visible light viewable by the average human eye when the composition is irradiated by white light.

10. The colorant composition of claim 1 wherein the wavelength range of visible light viewable by the average human eye when the composition is irradiated by UV light substantially overlaps with the wavelength range of the visible light viewable by the average human eye when the composition is irradiated by white light.

11. An article comprising a colorant composition disposed on at least a portion of a surface thereof, the colorant composition comprising a transparent or translucent visible light colorant, a UV fluorescent pigment, and a UV blocking compound.

12. The article of claim 11 wherein the colorant composition further comprises a binder that is transparent or translucent to both white light and the UV light wavelengths that cause the UV fluorescent pigment to fluoresce.

13. The article of claim 11 wherein the article is a canvas, a piece of glass, a wall, a building, a vehicle, an amusement park ride, or a sheet comprising paper, a woven or nonwoven fabric, metal, a thermoplastic polymer, or a combination of two or more thereof.

14. The article of claim 11 wherein the portion of the article having the colorant composition disposed thereon has an appearance whereby the wavelength range of visible light viewable by the average human eye when the disposed composition is irradiated by UV light at least partially overlaps with the wavelength range of the visible light viewable by the average human eye when the disposed composition is irradiated by white light.

15. The article of claim 11 wherein the disposing is accomplished by brushing, rolling, printing, or spraying.

16. A system for formulating a colorant composition, the system comprising at least three reservoirs, wherein each of the three reservoirs is in communication with a computer that directs the system to dispense a selected amount of the contents of each reservoir in a single location, the three reservoirs individually comprising a transparent or translucent visible light colorant, a UV fluorescent pigment, and a UV blocking compound.

17. The system of claim 16 wherein the system is a latex paint formulation system and the location is a container; wherein one or more of the reservoirs further comprises a binder and a coalescing solvent; and wherein the system further comprises a mixing mechanism to mix the dispensed contents.

18. The system of claim 16 wherein the system is an inkjet printer, the reservoirs are inkjet cartridges, and the location of dispensing is on an article; wherein the computer directs the system to repeat the dispensing a selected number of times at a selected number of locations.

19. The system of claim 16 wherein the system comprises at least seven reservoirs, wherein the first, second, and third reservoirs comprise three different transparent or translucent visible light colorants, the fourth, fifth, and sixth reservoirs comprise three different UV fluorescent pigment, and the seventh reservoir comprises at least a UV blocking compound.

20. The system of claim 16, wherein the system further comprises one or more additional reservoirs comprising one or more of carbon black, titanium dioxide, or a UV fluorescent dye.
